(19) United States
(12) Patent Application Publication
(10) Pub. No.: US 2021/0218243 A1
(43) Pub. Date: Jul. 15, 2021

(54) SYSTEMS AND METHODS FOR PROTECTING A CIRCUIT, RECHARGEABLE ELECTROCHEMICAL CELL, OR BATTERY

(71) Applicant: Sion Power Corporation, Tucson, AZ (US)

(72) Inventors: Glenn Alan Hamblin, Tucson, AZ (US); David Warren Ribblett, Vail, AZ (US); Shea Thomas Ribblett, Vail, AZ (US); James Anthony Bock, Oro Valley, AZ (US)

(73) Assignee: Sion Power Corporation, Tucson, AZ (US)

(21) Appl. No.: 17/126,424

(22) Filed: Dec. 18, 2020

Related U.S. Application Data
(60) Provisional application No. 62/951,225, filed on Dec. 20, 2019.
(60) Provisional application No. 62/951,236, filed on Dec. 20, 2019.

(51) Int. Cl. H02H 7/18; H02J 7/00

(52) U.S. Cl. CPC H02H 7/18; H02J 7/0031; H02J 7/00304

(57) ABSTRACT

A system for protecting at least one electrochemical cell, comprising circuitry configured to disconnect the at least one electrochemical cell at a first threshold current magnitude based on a first current flow direction through at least one relay and at a second threshold current magnitude based on a second current flow direction through the at least one relay, wherein the first current flow direction is different from the second current flow direction. A method for electrochemical cell protection. A system comprising circuitry configured to disconnect at least one portion of a circuit at a first threshold current magnitude based on a first current flow direction through at least one relay and at a second threshold current magnitude based on a second current flow direction through the at least one relay. A method for protecting at least one portion of a circuit.

### RELATED APPLICATIONS

This application claims priority under 35 U.S.C. 119(e) to U.S. Provisional Application No. 62/951,225, filed Dec. 20, 2019, and entitled “Systems and Methods for Protecting a Circuit, Rechargeable Electrochemical Cell, or Battery”, and to U.S. Provisional Application No. 62/951,236, filed Dec. 20, 2019, and entitled “System and Method for Circuit Protection”, each of which is incorporated herein by reference in its entirety.

### TECHNICAL FIELD

Circuit protection, including protection of electrochemical cells, and related systems and methods, are generally described.

### BACKGROUND

Conventionally, batteries have failed to compete successfully with established power sources such as combustion engines in various industries, such as vehicles. One reason for this failure has been that battery users have been dissatisfied with the longevity and reliability that batteries have conventionally provided.

### SUMMARY

Disclosed herein are embodiments related to protection of a circuit and electrochemical cells and related systems. The subject matter of the present invention involves, in some cases, interrelated products, alternative solutions to a particular problem, and/or a plurality of different uses of one or more systems and/or articles.

Some embodiments are directed to a system for protecting at least one electrochemical cell. The system may comprise circuitry configured to disconnect the at least one electrochemical cell at a first threshold current magnitude based on a first current flow direction through at least one relay; and disconnect the at least one electrochemical cell at a second threshold current magnitude based on a second current flow direction through the at least one relay, wherein the first current flow direction is different from the second current flow direction.

Some embodiments are directed to a method for protecting at least one electrochemical cell. The method may comprise disconnecting the at least one electrochemical cell at a first threshold current magnitude based on a first current flow direction through at least one relay; and disconnecting the at least one electrochemical cell at a second threshold current magnitude based on a second current flow direction through the at least one relay, wherein the first current flow direction is different from the second current flow direction.

Certain embodiments are directed to a system comprising circuitry configured to disconnect at least one portion of a circuit at a first threshold current magnitude based on a first current flow direction through at least one relay; and disconnect the at least one portion of the circuit at a second threshold current magnitude based on a second current flow direction through the at least one relay, wherein the first current flow direction is different from the second current flow direction.

Further embodiments are directed to a method for protecting at least one portion of a circuit. The method may comprise disconnecting the at least one portion of the circuit at a first threshold current magnitude based on a first current flow direction through at least one relay; and disconnecting the at least one portion of the circuit at a second threshold current magnitude based on a second current flow direction through the at least one relay, wherein the first current flow direction is different from the second current flow direction.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a block diagram illustrating a representative electrochemical cell protection system, according to some embodiments.

FIG. 1B is a block diagram illustrating a representative circuit protection system, according to some embodiments.

FIG. 2 is a circuit diagram illustrating a representative circuit protection system, according to some embodiments.

FIG. 3A is a block diagram illustrating a representative battery management system, according to some embodiments.

FIG. 3B is a block diagram illustrating a representative battery pack, according to some embodiments.

FIG. 4 is a flow chart depicting a representative electrochemical cell protection process, according to some embodiments.

FIG. 5 is a flow chart depicting an additional representative electrochemical cell protection process, according to some embodiments.

FIG. 6 is a flow chart depicting a representative circuit protection process, according to some embodiments.

FIG. 7 is a flow chart depicting an additional representative circuit protection process, according to some embodiments.

FIG. 8 is a block diagram depicting a representative computing system that may be used to implement certain aspects.

### DETAILED DESCRIPTION

The inventors have recognized and appreciated that conventional circuits frequently are insufficiently protected, especially with regards to battery cells and packs. Conventionally, a battery pack may suffer a pack split caused by a module failure in the pack. This type of failure would cause a reverse voltage across the modules, harming module components.

The inventors have recognized and appreciated that such problems can be avoided, but conventional solutions, to the extent they exist, are too expensive, heavy, and large. The inventors have recognized and appreciated that more cost-, mass-, and volume-efficient structures and techniques for protecting a circuit, especially for battery cells, are possible. For example, the inventors have recognized and appreciated that, in accordance with certain embodiments, the battery pack or module may be disconnected from a load or charging source in case fault limits are reached or if any battery cell within the pack or module is operated outside of its limits, such as over/under voltage, over current, over/under temperature, and so on.

The inventors have additionally recognized and appreciated that some conventional protection systems for battery cells have a magnetic blowout that can only be connected in one direction, and they require one connection to a charging source and a separate connection to load, which increases cost, mass, and volume.

The inventors have also recognized and appreciated that, in accordance with certain embodiments, one way to provide this more cost-, mass-, and volume-efficient circuit protection is with a bi-directional relay with asymmetrical direct current circuit breaking. The inventors have recognized and appreciated that, in accordance with certain embodiments, asymmetrical circuit breaking provides different current limits for different current directions, such as for charging and discharging. The inventors have recognized and appreciated that electrochemical cells may have a different capacity for charging versus discharging and therefore may require or justify different protection modes for charging versus discharging. For example, some embodiments herein may prevent cell(s) from being charged or discharged outside certain current ranges that are safe or most efficient for the cell(s), which may be different between charging and discharging for a given cell or battery.

The inventors have recognized and appreciated that modules like battery modules may be protected by disconnecting modules from a load and/or charging source, which may be performed by circuitry such as a relay in some embodiments herein. In some embodiments, the relay may control current flow in an on/off and a bi-directional manner. The inventors have recognized and appreciated that, in accordance with certain embodiments, the relay can turn on/off depending on inputs, which can be used to control a charge or discharge state. In some embodiments, this asymmetry may be provided by tying in a current measuring control circuit to activate the relay function. The inventors have recognized and appreciated that conventional techniques for management and operation of rechargeable electrochemical cells have resulted in the previously poor longevity and performance of cells (and batteries in which they may be included). For example, cells have suffered a short cycle life (e.g., a low number of complete charge and discharge cycles before capacity falls below 80% of original capacity, as cells typically do at some point after sufficient usage), particularly where charge and discharge rates are similar, or where the charge rate is higher than the discharge rate. For example, many users of cells in batteries have desired the batteries to have nearly identical charge and discharge rates (e.g., 4 hours to charge and 4 hours to discharge), and battery manufacturers have provided batteries and battery management systems that provide such nearly identical rates. Many users have also desired batteries to charge at higher rates than they discharge (e.g., 30 minutes to charge and 4 hours to discharge) for various reasons, such as to reduce inconvenience of waiting for charging to use the batteries.

The inventors have further recognized and appreciated that the cycle life of a cell (and a battery including the cell), and consequently the longevity and performance of the cell (and battery), may be greatly improved by employing higher ratios of discharge rate to charge rate, in accordance with certain embodiments. Furthermore, the inventors have recognized and appreciated that, in accordance with certain embodiments, these ratios may be employed by providing a cell and/or battery management system that controls the cell or cells to provide such ratios.

For example, some embodiments are directed to a cell management system that controls a cell such that, for at least a portion of a charge cycle, the cell is charged at a charging rate or current that is lower than a discharging rate or current of at least a portion of a previous discharge cycle.

Some embodiments, such as embodiments having multiple cells, are directed to a battery management system that multiplexes cells such that the cells can be charged all at once (or with multiple cells discharged at the same time) and discharged individually or in smaller sets. This may result in actual ratios of discharge rate to charge rate for the cells that improve their cycle life, while providing whatever output rates that are desired or required for particular loads and applications. Furthermore, the inventors have recognized and appreciated that, in accordance with certain embodiments, discharging some but not all of the cells at once with homogeneous current distribution may also improve their cycle life.

For example, with a battery having 4 cells, 1 cell could be discharged at a time at 0.5 amperes for 3 hours each, and then all 4 cells could be charged at 0.5 amperes for 12 hours—such a configuration would provide an actual ratio of discharge rate to charge rate of 4:1, while the ratio from the user's perspective would be 1:1 because the cells are discharged individually for 3 hours each (totaling 12 hours of discharge time). The inventors have recognized and appreciated that, in accordance with certain embodiments, such a battery management system may actually improve the cycle life of batteries while still providing users what they desire or need from the batteries. In some embodiments, the functionality providing this duo of benefits may be hidden from users and may be integrated into the cell blocks and/or batteries themselves.

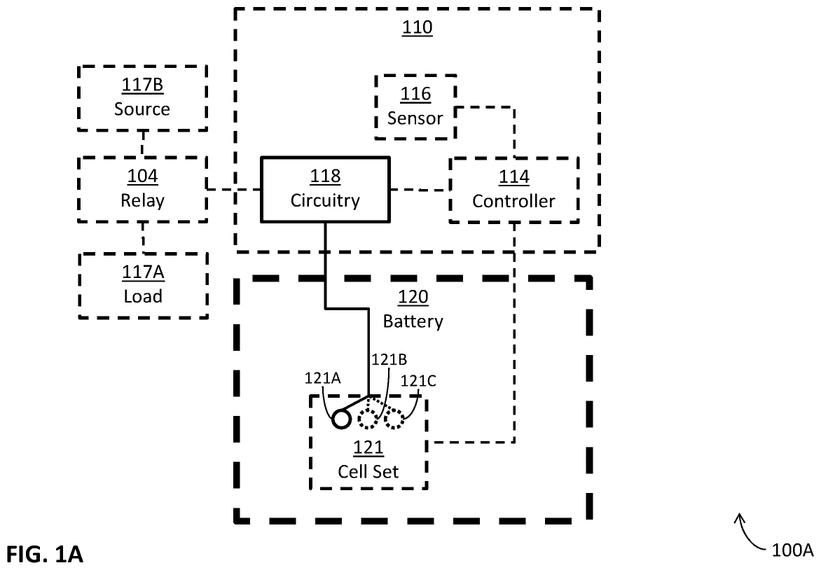

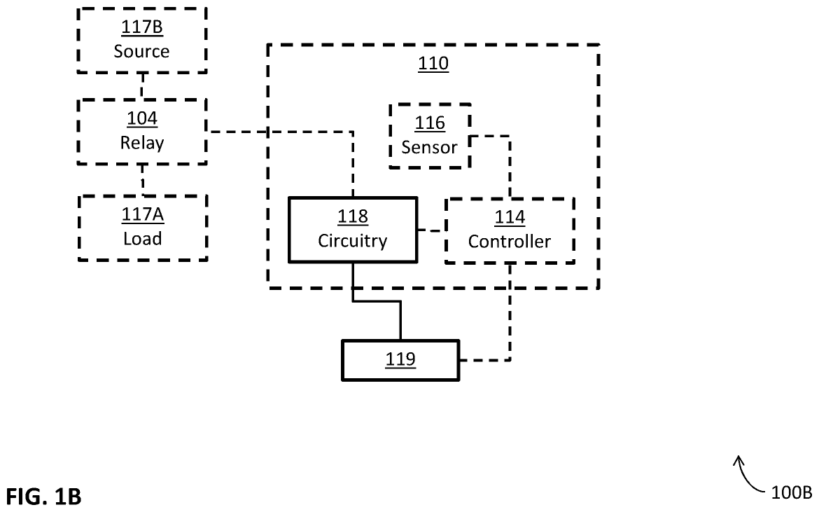

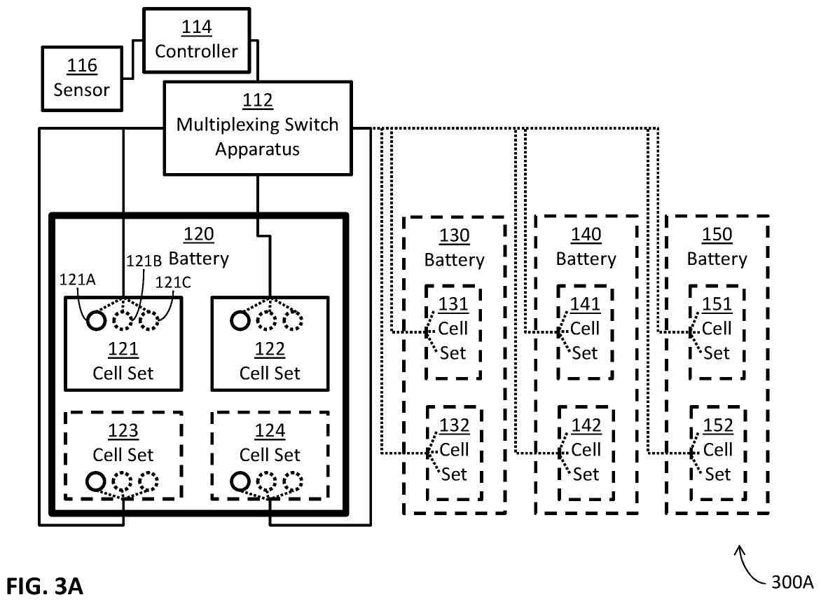

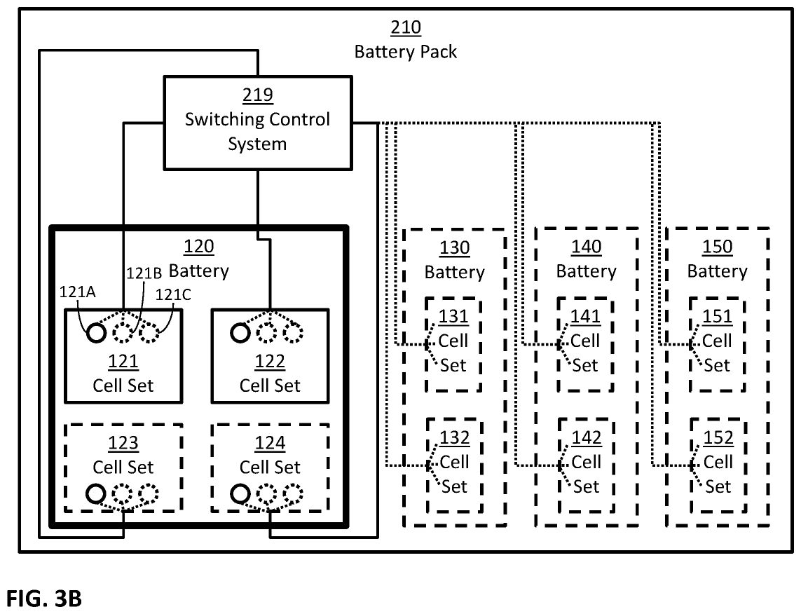

FIG. 1A depicts a representative electrochemical cell protection system 100A. In some embodiments, representative system 100A may include circuitry (e.g., 118), which may include or be connected to a controller (e.g., 114) and/or one or more sensors (e.g., 116). In some embodiments, the system may include an electrochemical cell (e.g., 121A). In some embodiments, cell 121A may be present alone. In other embodiments, additional cells (e.g., optional cells 121B and 121C in FIG. 1A) and/or additional cell sets (e.g., optional cell set 122 in FIG. 1A) may be present (e.g., to form battery 120). In some embodiments, the cell(s) may be part of a battery pack (e.g., 210 shown in FIG. 3B). In some embodiments, the circuitry may be connected between the cell(s) and a load (e.g., 117A) and/or a charging source (e.g., 117B). In some embodiments, this connection may include at least one relay (e.g., 104), which may also be included as part of the circuitry. In some embodiments, the cell(s) may be both charged and discharged along the same electrical path (e.g., through relay 104, circuitry 118, and so on).

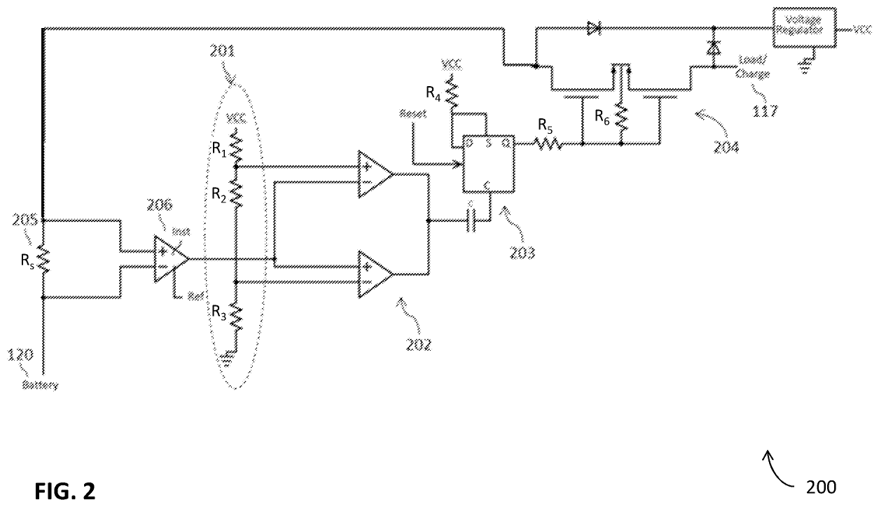

In some embodiments, representative system 100A may include the controller (e.g., 114). In some embodiments, system 100A may include the one or more sensors (e.g., 116). For example, the sensor(s) may include at least one current measuring control, which may measure operating current in a first current flow direction and/or operating current in a second current flow direction. In some embodiments, in response to measuring a threshold current in the first current flow direction and/or a threshold current in the second current flow direction through at least one relay, the circuitry may be activated to perform a disconnection of the cell(s) (e.g., from the load and/or charging source). This activation may be performed by the controller in some embodiments, and/or by the at least one current measuring control. In some embodiments, the current measuring control may include a current measuring circuitry and the controller, such as is discussed in relation to FIG. 2. For example, the current measuring circuitry may include the circuitry of 206, 201, and 202, and the controller may include circuitry 203. In some embodiments, the threshold may include fault or operational limits such as voltage or temperature. In some embodiments, the current measuring control may be analog. Alternatively, the current measuring control may be digital. For example, at least a portion of the current measuring control may digitize output from the instrumentation amplifier (e.g., 206), such as by using an analog-to-digital converter, and determine the direction of the current flow based on which of multiple digital signals is produced.

In some embodiments, the circuitry may disconnect the cell(s) at the first threshold current magnitude based on the first current flow direction through the relay(s), and/or the circuitry may disconnect at the second threshold current magnitude based on the second current flow direction through the relay(s).

In some embodiments, the first threshold current magnitude may be different from the second threshold current magnitude. In some embodiments, the first threshold current magnitude may be at least 0.1 amperes, at least 1 ampere, at least 5 amperes, or at least 10 amperes higher than the second threshold current. In some embodiments, the first threshold current magnitude may be as much as 50 amperes, as much as 100 amperes, as much as 500 amperes, or as much as 1000 amperes higher than the second threshold current. For example, the first threshold current magnitude may be 25 amperes, 50 amperes, 100 amperes, 300 amperes, 500 amperes, or anywhere in between (in some embodiments, an additional 0.01 amperes may be added to any of these); and the second threshold current magnitude may be 1 ampere, 6 amperes, 12 amperes, 25 amperes, 75 amperes, 125 amperes, or anywhere in between (in some embodiments, an additional 0.01 amperes may be added to any of these). Alternatively, the first threshold current magnitude may be the same as the second threshold current magnitude. In some embodiments, the current thresholds may be just above the maximum current expected and no higher than a given cell arrangement can safely provide or take, respectively.

In some embodiments, the first current flow direction may be different from the second current flow direction. For example, the first and second current flow directions may be opposite each other (such as one incoming and the other outgoing). In some embodiments, the cell(s) may be disconnected at one or more portions of the circuit or positions within the system. The inventors have recognized and appreciated that, in accordance with certain embodiments, this may allow circuit breaking at any point within, for example, a battery pack circuit.

In some embodiments, these threshold currents may be currents of discharging or charging the cell(s). For example, the first current flow direction may correspond to discharging of the cell(s). Alternatively or additionally, the second current flow direction may correspond to charging of the cell(s).

In some embodiments, the operating current in the first current flow direction and/or the operating current in the second current flow direction may be or include direct current. The inventors have recognized and appreciated that, in accordance with certain embodiments, providing the features herein for direct current may be especially appropriate for usage with battery cells.

In some embodiments, the relay(s) may include at least some solid state components, such as one or more transistor(s) disposed/formed on one or more semiconductor dies within an integrated circuit package. The inventors have recognized and appreciated that solid state relays lack physical contact points to arc, burn, or degrade in comparison with non-solid state relays. Moreover, solid state relays require less power to switch on and off than non-solid state. Additionally, solid state relays do not require more power to turn on as the current through them increases, unlike non-solid state, which require increasingly larger relay(s) for higher current scenarios. Alternatively, the relay(s) may include at least one electro-mechanical switch.

In some embodiments, the first threshold current magnitude and/or the second threshold current magnitude may be automatically and/or manually adjusted, such as in response to operating conditions of the system. For example, if something changes that requires the threshold current to be lower or higher for either direction, the threshold can be changed accordingly. Alternatively or additionally, as cell(s) are used and the desired ratio of charge to discharge rates changes, the threshold currents may be adjusted to meet any such desired ratio.

In some embodiments, the average operating current in the first current flow direction (e.g., the discharging direction) may be at least 2 times higher than the average operating current in the second current flow direction (e.g., the charging direction). For example, the average operating current in the first current flow direction may be 4 times higher than average operating current in the second current flow direction.

In some embodiments, the circuitry used to perform the described disconnection may be included within a single integrated circuit package, or as a single component, either of which may include any combination of circuitry 118, controller 114, and/or sensor 116 (e.g., as integrated circuit package or single component 110). For example, an exemplary integrated circuit package may include the circuitry shown in FIG. 2 disposed/formed on one or more semiconductor dies. Some embodiments may not include the resistor 205, resistor(s) 201, and transistors 204 within the integrated circuit package. For example, the resistor 205 and transistors 204 may be included as part of a charging/discharging circuit separate from the integrated circuit package. In another example, the resistors 201 may be coupled to the integrated circuit package and accessible for reconfiguration by a user (e.g., users may provide their own resistors 201), such as to set threshold current magnitudes of the system. An exemplary single component may include the integrated circuit package (e.g., alone or in combination with other circuitry) mounted (e.g., surface-mounted) or otherwise attached to a single substrate, such as a printed circuit board.

In some embodiments, the cell(s) may be reconnected within a time interval of disconnecting the cell(s). For example, the circuitry may allow for reconnection of disconnected cell(s) by closing the relay(s) within a time interval of less than 1 second (i.e., a “quick reset” of the relay(s)) after disconnecting the cell(s). In some embodiments, this reconnection may be performed within a time interval of 5 microseconds or less after the disconnection. The inventors have recognized and appreciated that, in accordance with certain embodiments, such fast reconnection may be possible using a solid state relay.

It should be appreciated that although only a single controller 114 and a single sensor 116, and others, are shown in FIG. 1A, any suitable number of these components may be used. Any of numerous different modes of implementation may be employed.

According to some embodiments, the cell(s) may include at least one lithium-metal electrode active material. Additionally, each set of cells (e.g., cell set 121) may include one or more cells (e.g., 121A-121C). In some embodiments, each set of cells may have a single cell. Alternatively, each set of cells may include multiple cells and may form a cell “block,” or multiple sets of cells may together form a cell block. Additionally, each cell (either in a battery, all the batteries in a battery pack, or in a set of cells) or set of cells may utilize the same electrochemistry. That is to say, in some embodiments, each cell may make use of the same anode active material and the same cathode active material.

In some embodiments, such as embodiments having multiple cells, a multiplexing switch apparatus (not shown in FIG. 1A) may be included, such as described in relation to FIG. 3A below, and may include an array of switches, such as those further described in relation to FIGS. 3A and 3B below. Additionally, the multiplexing switch apparatus may be connected to each set of cells and/or to each cell individually. In some embodiments, the controller, such as 114, may use the multiplexing switch apparatus to selectively discharge the cells or sets of cells.

In some embodiments, the controller (e.g., 114) may include a programmable logic array, such as a field programmable gate array (FPGA) and/or an application specific integrated circuit (ASIC). Alternatively or additionally, the controller may include one or more processors, which may be of whatever complexity is suitable for the application. Alternatively or additionally, the controller may include analog control circuitry, such as a feedback control loop.

In some embodiments, the controller may control the cell(s) such that, for at least a portion of a charge cycle of the cell(s), the cell(s) are charged at a charging rate or current that is lower than a discharging rate or current of at least a portion of a previous discharge cycle. For example, the controller may cause the cell(s) to be charged for some percentage of the cell's re-charge capacity (e.g., anywhere from 1% to 100% of re-charge capacity) at a charging rate or current that is on average at least 2 times lower than the discharging rate or current that has been used on average for some percentage of the cell(s)'s discharge capacity (e.g., anywhere from 1% to 100% of discharge capacity) (i.e., the charging rate or current is half as fast as the discharging rate or current). Alternatively or additionally, the controller may cause the cell(s) to be charged at a charging rate or current that is at least 4 times lower than the discharging rate (e.g., as a result of this controlling, over the last discharge/charge cycle, the cell(s) are charged for some percentage of the cell(s)'s re-charge capacity one-fourth as fast as the cell(s) have been discharged for some percentage of the cell(s)'s discharge capacity). The inventors have recognized and appreciated that, in accordance with certain embodiments, such ratios of charge rate to discharge rate may improve the performance and cycle life of a cell.

In some embodiments, controlling the cell may include controlling when and how to start and stop charging and discharging, induce discharging, increase or decrease the rate or current of charging or discharging, and so on. For example, controlling charging or discharging of the cell may include, respectively, starting charging or discharging, stopping charging or discharging, increasing or decreasing the rate or current of charging or discharging, and so on.

The term “complete charge cycle” is used herein to generally refer to a period of time during which about 100% of a cell's re-charge capacity is charged, and the term “complete discharge cycle” is used to generally refer to a period of time during which about 100% of the cell's discharge capacity (which may be different from its re-charge capacity) is discharged. On the other hand, the term “charging step” is used herein to generally refer to a continuous period of time during which charging is performed without discharging, and the term “discharging step” is used herein to generally refer to a continuous period during which discharging is performed without charging.

The term “charge cycle” is used to generally refer to a period of time during which the cell is charged, and it need not be a complete charge cycle. The term “discharge cycle” is used to generally refer to a period of time during which the cell is discharged, and it need not be a complete discharge cycle. The term “previous discharge cycle” is used to generally refer to a period of time during which the cell has been or is being discharged. For example, this “previous” discharge cycle may have been completed or may still be in progress—it need not refer to the most recent completed discharging steps that sum to about 100% of the cell's discharge capacity. If no complete discharge cycle has been performed, the previous discharge cycle may refer to any previously completed discharging steps.

The term “capacity” is used to generally refer to an amount of electrical charge a cell or cells can deliver at a given or rated voltage and is often measured in amp-hours (such as milliamp-hours or mAh). In some embodiments, capacity may be the mAh a cell or cells can hold at a given point in time (which may change over multiple charge or discharge cycles), it may be the mAh remaining in a cell or cells at a given point in time, or it may be the mAh a cell or cells need to fully re-charge.

As used herein, when a cell is charged at multiple different rates over a given period of time (e.g., over a portion of a charging step, over an entire charging step, or over a series of charging steps), the average charging rate over that given period of time is calculated as follows:

$${CR}_{Avg} = {\sum }_{i = 1}^{n} \frac{{CCap}_{i}}{{CCap}_{Total}} {CR}_{i}$$

where CR_{Avg} is the average charging rate over the given period of time, n is the number of different rates at which the cell is charged, CRi is the charging rate, CCapᵢ is the portion of the cell's re-charge capacity that is charged at charging rate CRᵢ during the given period of time, and CCap_{Total} is the total of the cell's re-charge capacity that is charged over the entire period of time. To illustrate, if, during a charging step, a cell is charged from 0% to 50% of its re-charge capacity at a rate of 20 mAh/minute and then from 50% to 80% of its re-charge capacity at a rate of 10 mAh/minute, then the average charging rate during the charging step would be calculated as:

$${CR}_{Avg} = \frac{50 \%}{80 \%} ( 20 mAh \text{/} min ) + \frac{30 \%}{80 \%} ( 10 mAh \text{/} min ) = 16.25 mAh \text{/} min .$$

As used herein, when a cell is discharged at multiple different rates over a given period of time (e.g., over a given charging step or series of charging steps), the average discharging rate over that given period of time is calculated as follows:

$${DR}_{Avg} = {\sum }_{i = 1}^{n} \frac{{DCap}_{i}}{{DCap}_{Total}} {DR}_{i}$$

where DR_{Avg} is the average discharging rate over the given period of time, n is the number of different rates at which the cell is discharged, DRᵢ is the discharging rate, DCapᵢ is the portion of the cell's discharge capacity that is discharged at discharging rate DRᵢ during the given period of time, and DCap_{Total} is the total of the cell's discharge capacity that is discharged over the entire period of time. To illustrate, if, during a discharging step, a cell is discharged from 90% to 50% of its discharge capacity at a rate of 25 mAh/minute and then from 50% to 20% of its discharge capacity at a rate of 15 mAh/minute, then the average discharging rate during the discharging step would be calculated as:

$${DR}_{Avg} = \frac{40 \%}{70 \%} ( 25 mAh \text{/} min ) + \frac{30 \%}{70 \%} ( 15 mAh \text{/} min ) = 20.71 mAh \text{/} min .$$

FIG. 1B depicts a representative circuit protection system 100B. In some embodiments, representative system 100B may include circuitry (e.g., 118), which may include or be connected to a controller (e.g., 114) and/or one or more sensors (e.g., 116). In some embodiments, the circuitry may be connected between a portion of the circuit (e.g., 119) and a load (e.g., 117A) and/or a charging source (e.g., 117B). In some embodiments, this connection may include at least one relay (e.g., 104), which may also be included as part of the circuitry.

In some embodiments, representative system 100B may include the controller (e.g., 114). In some embodiments, system 100B may include the one or more sensors (e.g., 116). For example, the sensor(s) may include at least one current measuring control, which may measure operating current in a first current flow direction and/or operating current in a second current flow direction. In some embodiments, in response to measuring a threshold current in the first current flow direction and/or a threshold current in the second current flow direction through at least one relay, the circuitry may be activated to perform a disconnection of the circuit portion(s) (e.g., from the load and/or charging source). This activation may be performed by the controller in some embodiments, and/or by the at least one current measuring control.

In some embodiments, the circuitry may disconnect the circuit portion(s) at the first threshold current magnitude based on the first current flow direction through the relay(s), and/or the circuitry may disconnect at the second threshold current magnitude based on the second current flow direction through the relay(s). In some embodiments, the first threshold current magnitude may be different from the second threshold current magnitude, such as is described in reference to FIG. 1A. Alternatively, the first threshold current magnitude may be the same as the second threshold current magnitude. In some embodiments, the current thresholds may be just above the maximum current expected and no higher than a given cell arrangement can safely provide or take, respectively.

In some embodiments, the first current flow direction may be different from the second current flow direction (e.g., as described in some embodiments herein).

In some embodiments, the circuit portion(s) may be disconnected at one or more positions within the system.

In some embodiments, such as where the circuit portion(s) include cell(s), these threshold currents may be currents of discharging or charging the cell(s). For example, the first current flow direction may correspond to discharging of the cell(s). Alternatively or additionally, the second current flow direction may correspond to charging of the cell(s).

In some embodiments, the operating current in the first current flow direction and/or the operating current in the second current flow direction may be or include direct current.

In some embodiments, the relay(s) may include solid state components (e.g., as described elsewhere herein).

In some embodiments, the first threshold current magnitude and/or the second threshold current magnitude may be automatically and/or manually adjusted. For example, if something changes that requires the threshold current to be lower or higher for either direction, the threshold can be changed accordingly.

In some embodiments, the average operating current in the first current flow direction (e.g., the discharging direction) may be at least 2 times higher than the average operating current in the second current flow direction (e.g., the charging direction). For example, the average operating current in the first current flow direction may be 4 times higher than average operating current in the second current flow direction.

In some embodiments, the circuitry used to perform the described disconnection may be included within a single integrated circuit package or as a single component, which may include any combination of circuitry 118, controller 114, and sensor 116 (e.g., as integrated circuit package or single component 110).

In some embodiments, the cell(s) may be reconnected within a time interval of disconnecting the cell(s) (e.g., as described elsewhere herein).

It should be appreciated that although only a single controller 114 and a single sensor 116, and others, are shown in FIG. 1B, as in FIG. 1A, any suitable number of these components may be used. Any of numerous different modes of implementation may be employed.

FIG. 2 depicts a representative circuit protection system 200. In some embodiments, the system 200 may include at least one load and/or charging source (e.g., 117, as described elsewhere herein) and at least one battery or cell(s) (e.g., 120, as described elsewhere herein). In some embodiments, the system 200 may include circuitry between these, such as is shown in FIG. 2, which may provide the features described herein.

In some embodiments, system 200 may include at least one relay, such as including the pair of transistors 204. Alternatively, the relay(s) may include at least one electro-mechanical switch. In some embodiments, the relay(s) may disconnect and reconnect the cell(s) with the load/charging source. In some embodiments, the relay(s) may be very low impedance transistors or switches able to handle very high current.

In some embodiments, system 200 may include at least one sense resistor (or shunt resistor), such as resistor 205. In some embodiments, the sense resistor may be positioned in the circuit between the cell(s) and the load/charging source. In some embodiments, the sense resistor may be in series with the relay(s). Alternatively, a first current (e.g., charge/discharge current) may go through the relay(s), and a second current that is representative of (e.g., proportional to) the first current may go through the sense resistor.

In some embodiments, system 200 may include at least one amplifier, such as instrumentation amplifier 206. In some embodiments, the sense resistor (e.g., 205) may generate a voltage representative of a current flowing between the cell(s) and the load/source. In some embodiments, the amplifier may determine the direction of the current flow based on the voltage across the sense resistor. For instance, in embodiments including an instrumentation amplifier, a voltage reference provided to the instrumentation amplifier may set a directional voltage threshold. As an example, voltages output from the instrumentation amplifier that are higher than the voltage reference may indicate current through the sense resistor in a first direction, and voltages higher than the voltage reference may indicate current through the sense resistor in a second direction opposite the first direction. In some embodiments, the voltage reference may be set to 0 volts. In other embodiments, the voltage reference may be set anywhere between 0 volts and a highest voltage of the circuit, or between 0 volts and a lowest voltage of the circuit.

In some embodiments, the sense resistor may have a resistance (e.g., Rₛ shown in FIG. 2) of 10 to 100 ohms, which the inventors have recognized may limit voltage drop and/or heat build-up.

In some embodiments, system 200 may include comparator circuitry, such as a dual-comparator configuration (e.g., 202). In some embodiments, the amplifier output(s) may be connected to one or more inputs of the comparator circuitry. In some embodiments, system 200 may include a resistive divider (e.g., a 3-resistor chain 201), which may be connected to other inputs of the comparator circuitry. In some embodiments, the resistive divider may set the threshold or trip current in each direction. For instance, resistance values of the resistors may control voltages input to the comparator circuitry for comparing against the output of the amplifier. The comparator(s) may output a signal indicating whether the output of the amplifier exceeds a voltage provided by the resistive divider, which may indicate whether the current sensed by the sense resistor exceeded a threshold in a particular direction. Accordingly, one way in which the current magnitudes may be set is by configuring resistance values of the resistive divider. It should be appreciated that any number of resistors may be included in the resistive divider, in accordance with various embodiments.

In some embodiments, the resistance of resistors in the resistive divider (e.g., R₁, R₂, and R₃, shown in FIG. 2) may be 10 to 100 kiloohms, which the inventors have recognized may limit power consumption.

In some embodiments, system 200 may include control circuitry, such as including a D flip-flop (e.g., 203) and/or a D latch, either or both of which may be disposed in an FPGA or ASIC. Alternatively, a microcontroller or processor may be configured to perform the functionality of the flip-flop or latch. In some embodiments, the control circuitry may include inputs D (data), S (set), and C (clear). Additionally, the control circuitry may include an output Q (result). In some embodiments, the control circuitry may include a reset input connected to a clock pin.

In some embodiments, the control circuitry may control the relay(s) based on the determined current flow direction and magnitude. For example, if the threshold magnitude for a given direction is met by the operating current, the comparator circuitry may output a signal indicative of the threshold being met to the control circuitry, causing the control circuitry to control the relay(s) to open, thus breaking the circuit. In some embodiments, the control circuitry may be configured to frequently monitor the sense resistor to detect whether a current magnitude threshold has been reached. For example, the C input of the illustrated control circuitry may be configured to update the Q output responsive to the comparator circuitry providing a signal indicating that a current magnitude threshold has been reached. In such a scenario, the Q output may provide a voltage to the relay that opens or closes the relay to disconnect or connect the battery from the load/charger. The reset input, coupled to the clock pin, may cause the control circuitry to frequently monitor the D, S, and/or C inputs (e.g., according to a clock signal). For example, the control circuitry may check the C input to determine the status of the current at the sense resistor with every clock signal pulse. In some embodiments, the clock signal may operate at a high frequency, such as hundreds of megahertz (MHz) or a few gigahertz (GHz), to facilitate a quick response to an over/under voltage or overcurrent condition, and/or to facilitate a quick return to normal operation once such a condition is no longer present. In embodiments that include a processor, outputs from the comparator circuitry may be input to the processor, and the processor may determine, based on an instruction set and a system clock, whether to open or close the relay to disconnect or connect the battery to the load/charger.

In some embodiments, system 200 may include resistors as shown in FIG. 2 with resistances R₄, R₅, and R₆. These resistance may have any suitable value for a given application, such as 10 ohms to 100 kiloohms.

In some embodiments, system 200 may be scalable. For example, more components of any kind may be added to make system 200 any appropriate size and suited for any appropriate number of external components, such as cells or loads or charging sources. In some embodiments, the system 200 may be tunable, such as by changing only some of the components, or changing component values (e.g., voltage references, resistor values, etc.). For example, system 200 is not limited to the circuit diagram shown in FIG. 2, as other components and configurations of the illustrated components may be used.

FIG. 3A depicts a representative battery management system 300A. In some embodiments, such as embodiments having multiple cells, representative system 300A may include a multiplexing switch apparatus (e.g., 112), a controller (e.g., 114), one or more sensors (e.g., 116), and one or more batteries (e.g., 120, 130, 140, 150, and so on). It should be appreciated that although only a single multiplexing switch apparatus 112, controller 114, sensor 116, and only four batteries 120-150 are shown in FIG. 3A, any suitable number of these components may be used. Any of numerous different modes of implementation may be employed. Furthermore, although a label in the singular is used herein to reference a multiplexing switch apparatus, it should be appreciated that the components used for the multiplexing and switching described herein may be distributed across any suitable number of devices (e.g., switches).

According to some embodiments, the battery or batteries may include at least one lithium-metal battery. Additionally, the battery or batteries (e.g., 120-150) may respectively include one or more cell sets (e.g., 121-124, 131-132, 141-142, 151-152, and so on), referred to also as sets of cells. In some embodiments, two or more sets of cells are included in each battery, such as 121-122 and so on. Additionally, each set of cells (e.g., cell set 121) may include one or more cells (e.g., 121A-121C). In some embodiments, each set of cells may have a single cell. Alternatively, each set of cells may include multiple cells and may form a cell “block,” or multiple sets of cells may together form a cell block. Additionally, each cell (either in a battery, all the batteries in a battery pack, or in a set of cells) or set of cells may utilize the same electrochemistry. That is to say, in some embodiments, each cell may make use of the same anode active material and the same cathode active material.

In some embodiments, the controller may use the multiplexing switch apparatus to selectively discharge and charge the cells or sets of cells at different, programmable rates. For example, the controller may use the multiplexing switch apparatus to selectively discharge the cells or sets of cells at a first rate at least 2 times higher than a second rate of charging the sets of cells (i.e., discharging twice as fast as charging). Alternatively or additionally, the first rate of discharging may be at least 4 times higher than the second rate of charging the sets of cells (i.e., discharging four times as fast as charging). The inventors have recognized and appreciated that, in accordance with certain embodiments, such ratios of discharge rate to charge rate may improve the performance and cycle life of the cells.

In some embodiments, the load may be at least one component of a vehicle. The vehicle may be any suitable vehicle, adapted for travel on land, sea, and/or air. For example, the vehicle may be an automobile, truck, motorcycle, boat, helicopter, airplane, and/or any other suitable type of vehicle.

Alternatively or additionally, the controller may use the multiplexing switch apparatus (e.g., 112) to connect the sets of cells to a load in a topology employed or required by the load.

In some embodiments, the controller may use the multiplexing switch apparatus (e.g., 112) to isolate a single set of cells for discharging while other sets of cells are not discharging. Alternatively or additionally, a single cell may be isolated at a time. For example, the controller may use the multiplexing switch apparatus to isolate a single set of cells or a single cell for discharging while the other cells or sets of cells are not discharging. For a given cycle, each cell may be discharged once before any cell is discharged twice, according to some embodiments (e.g., where sequential discharging is used, but not limited to such embodiments).

As for charging, in some embodiments the controller may use the multiplexing switch apparatus to charge the sets of cells, and/or cells within a set, in parallel. For example, all the cells in the cell block, battery, or batteries may be charged in parallel at a rate one-fourth of the rate of discharge.

FIG. 3B depicts a representative battery pack 210. In some embodiments, representative battery pack 210 may include a switching control system (e.g., 218) and one or more batteries (e.g., 120, 130, 140, 150, and so on). It should be appreciated that although only a single switching control system 218 and only four batteries 120-150 are shown in FIG. 3B, any suitable number of these components may be used. Any of numerous different modes of implementation may be employed. Furthermore, although a label in the singular is used herein to reference a switching control system, it should be appreciated that the components used for the control and switching described herein may be distributed across any suitable number of devices (e.g., switches, controller(s), etc.).

In some embodiments, a switching control system (e.g., 218) may include an array of switches, such as those further described in relation to FIGS. 3A and 3B below, and it may include a controller. Additionally, the switching control system may be connected to each set of cells and/or to each cell of the batteries individually, as discussed regarding FIG. 3A above. In some embodiments, the switching control system may be integrated into the battery pack.

According to some embodiments, the switching control system may perform any number of other functions, such as those of the controller described in relation to FIGS. 1A-1B and 3A above.

It should be appreciated that any of the components of representative system 300A or representative battery pack 210 may be implemented using any suitable combination of hardware and/or software components. As such, various components may be considered a controller that may employ any suitable collection of hardware and/or software components to perform the described function.

The anodes of the electrochemical cells described herein may comprise a variety of anode active materials. As used herein, the term “anode active material” refers to any electrochemically active species associated with the anode. For example, the anode may comprise a lithium-containing material, wherein lithium is the anode active material. Suitable electroactive materials for use as anode active materials in the anode of the electrochemical cells described herein include, but are not limited to, lithium metal such as lithium foil and lithium deposited onto a conductive substrate, and lithium alloys (e.g., lithium-aluminum alloys and lithium-tin alloys). Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

In one embodiment, an electroactive lithium-containing material of an anode active layer comprises greater than 50% by weight of lithium. In another embodiment, the electroactive lithium-containing material of an anode active layer comprises greater than 75% by weight of lithium. In yet another embodiment, the electroactive lithium-containing material of an anode active layer comprises greater than 90% by weight of lithium. Additional materials and arrangements suitable for use in the anode are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

The cathodes in the electrochemical cells described herein may comprise a variety of cathode active materials. As used herein, the term “cathode active material” refers to any electrochemically active species associated with the cathode. Suitable electroactive materials for use as cathode active materials in the cathode of the electrochemical cells of some embodiments include, but are not limited to, one or more metal oxides, one or more intercalation materials, electroactive transition metal chalcogenides, electroactive conductive polymers, sulfur, carbon and/or combinations thereof.

In some embodiments, the cathode active material comprises one or more metal oxides. In some embodiments, an intercalation cathode (e.g., a lithium-intercalation cathode) may be used. Non-limiting examples of suitable materials that may intercalate ions of an electroactive material (e.g., alkaline metal ions) include metal oxides, titanium sulfide, and iron sulfide. In some embodiments, the cathode is an intercalation cathode comprising a lithium transition metal oxide or a lithium transition metal phosphate. Additional examples include LiₓCoO₂ (e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, LiCoₓNi₍ᵢ₋ₓ₎O₂, and LiCoₓNi_{y}Mn_{(i-x-y)}O₂ (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). X may be greater than or equal to 0 and less than or equal to 2. X is typically greater than or equal to 1 and less than or equal to 2 when the electrochemical cell is fully discharged, and less than 1 when the electrochemical cell is fully charged. In some embodiments, a fully charged electrochemical cell may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the electroactive material within the cathode comprises lithium transition metal phosphates (e.g., LiFePO₄), which can, in certain embodiments, be substituted with borates and/or silicates.

As noted above, in some embodiments, the cathode active material comprises one or more chalcogenides. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of some embodiments may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

In some embodiments, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of some embodiments may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Additional materials suitable for use in the cathode, and suitable methods for making the cathodes, are described, for example, in U.S. Pat. No. 5,919,587, filed May 21, 1997, entitled “Novel Composite Cathodes, Electrochemical Cells Comprising Novel Composite Cathodes, and Processes for Fabricating Same,” and U.S. Patent Publication No. 2010/0035128 to Scordilis-Kelley et al. filed on Aug. 4, 2009, entitled “Application of Force in Electrochemical Cells,” each of which is incorporated herein by reference in its entirety for all purposes.

A variety of electrolytes can be used in association with the electrochemical cells described herein. In some embodiments, the electrolyte may comprise a non-solid electrolyte, which may or may not be incorporated with a porous separator. As used herein, the term “non-solid” is used to refer to materials that are unable to withstand a static shear stress, and when a shear stress is applied, the non-solid experiences a continuing and permanent distortion. Examples of non-solids include, for example, liquids, deformable gels, and the like.

The electrolytes used in electrochemical cells described herein can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material facilitates the transport of ions (e.g., lithium ions) between the anode and the cathode. Exemplary materials suitable for use in the electrolyte are described, for example, in U.S. Patent Publication No. 2010/0035128 to Scordilis-Kelley et al. filed on Aug. 4, 2009, entitled “Application of Force in Electrochemical Cells,” which is incorporated herein by reference in its entirety for all purposes.

U.S. application Ser. No. 16/527,903, filed Jul. 31, 2019, and entitled “Multiplexed Charge Discharge Battery Management System” is incorporated herein by reference in its entirety for all purposes. U.S. application Ser. No. 16/670,905, filed Oct. 31, 2019, and entitled “System and Method for Operating a Rechargeable Electrochemical Cell or Battery” is incorporated herein by reference in its entirety for all purposes.

The following documents are incorporated herein by reference in their entireties for all purposes: U.S. Pat. No. 7,247,408, filed May 23, 2001, entitled “Lithium Anodes for Electrochemical Cells”; U.S. Pat. No. 5,648,187, filed Mar. 19, 1996, entitled “Stabilized Anode for Lithium-Polymer Batteries”; U.S. Pat. No. 5,961,672, filed Jul. 7, 1997, entitled “Stabilized Anode for Lithium-Polymer Batteries”; U.S. Pat. No. 5,919,587, filed May 21, 1997, entitled “Novel Composite Cathodes, Electrochemical Cells Comprising Novel Composite Cathodes, and Processes for Fabricating Same”; U.S. patent application Ser. No. 11/400,781, filed Apr. 6, 2006, published as U. S. Pub. No. 2007-0221265, and entitled “Rechargeable Lithium/Water, Lithium/Air Batteries”; International Patent Apl. Serial No.: PCT/US2008/009158, filed Jul. 29, 2008, published as International Pub. No. WO/2009017726, and entitled “Swelling Inhibition in Lithium Batteries”; U.S. patent application Ser. No. 12/312,764, filed May 26, 2009, published as U.S. Pub. No. 2010-0129699, and entitled “Separation of Electrolytes”; International Patent Apl. Serial No.: PCT/US2008/012042, filed Oct. 23, 2008, published as International Pub. No. WO/2009054987, and entitled “Primer for Battery Electrode”; U.S. patent application Ser. No. 12/069,335, filed Feb. 8, 2008, published as U.S. Pub. No. 2009-0200986, and entitled “Protective Circuit for Energy-Storage Device”; U.S. patent application Ser. No. 11/400,025, filed Apr. 6, 2006, published as U.S. Pub. No. 2007-0224502, and entitled “Electrode Protection in both Aqueous and Non-Aqueous Electrochemical Cells, including Rechargeable Lithium Batteries”; U.S. patent application Ser. No. 11/821,576, filed Jun. 22, 2007, published as U.S. Pub. No. 2008/0318128, and entitled “Lithium Alloy/Sulfur Batteries”; patent application Ser. No. 11/111,262, filed Apr. 20, 2005, published as U.S. Pub. No. 2006-0238203, and entitled “Lithium Sulfur Rechargeable Battery Fuel Gauge Systems and Methods”; U.S. patent application Ser. No. 11/728,197, filed Mar. 23, 2007, published as U.S. Pub. No. 2008-0187663, and entitled “Co-Flash Evaporation of Polymerizable Monomers and Non-Polymerizable Carrier Solvent/Salt Mixtures/Solutions”; International Patent Apl. Serial No.: PCT/US2008/010894, filed Sep. 19, 2008, published as International Pub. No. WO/2009042071, and entitled “Electrolyte Additives for Lithium Batteries and Related Methods”; International Patent Apl. Serial No.: PCT/US2009/000090, filed Jan. 8, 2009, published as International Pub. No. WO/2009/089018, and entitled “Porous Electrodes and Associated Methods”; U.S. patent application Ser. No. 12/535,328, filed Aug. 4, 2009, published as U.S. Pub. No. 2010/0035128, and entitled “Application of Force In Electrochemical Cells”; U.S. patent application Ser. No. 12/727,862, filed Mar. 19, 2010, entitled “Cathode for Lithium Battery”; U.S. Pat. No. 12,471,095, filed May 22, 2009, entitled “Hermetic Sample Holder and Method for Performing Microanalysis Under Controlled Atmosphere Environment”; U.S. patent application Ser. No. 12/862,513, filed on Aug. 24, 2010, entitled “Release System for Electrochemical cells (which claims priority to Provisional Patent Apl. Ser. No. 61/236,322, filed Aug. 24, 2009, entitled “Release System for Electrochemical Cells”); U.S. Provisional Patent Apl. Ser. No. 61/376,554, filed on Aug. 24, 2010, entitled “Electrically Non-Conductive Materials for Electrochemical Cells;” U.S. Provisional patent application Ser. No. 12/862,528, filed on Aug. 24, 2010, entitled “Electrochemical Cell;” U.S. patent application Ser. No. 12/862,563, filed on Aug. 24, 2010, published as U.S. Pub. No. 2011/0070494, entitled “Electrochemical Cells Comprising Porous Structures Comprising Sulfur”; U.S. patent application Ser. No. 12/862,551, filed on Aug. 24, 2010, published as U.S. Pub. No. 2011/0070491, entitled “Electrochemical Cells Comprising Porous Structures Comprising Sulfur”; U.S. patent application Ser. No. 12/862,576, filed on Aug. 24, 2010, published as U.S. Pub. No. 2011/0059361, entitled “Electrochemical Cells Comprising Porous Structures Comprising Sulfur”; U.S. patent application Ser. No. 12/862,581, filed on Aug. 24, 2010, published as U.S. Pub. No. 2011/0076560, entitled “Electrochemical Cells Comprising Porous Structures Comprising Sulfur”; U.S. Patent Apl. Ser. No. 61/385,343, filed on Sep. 22, 2010, entitled “Low Electrolyte Electrochemical Cells”; and U.S. patent application Ser. No. 13/033,419, filed Feb. 23, 2011, entitled “Porous Structures for Energy Storage Devices”. All other patents and patent applications disclosed herein are also incorporated by reference in their entirety for all purposes.

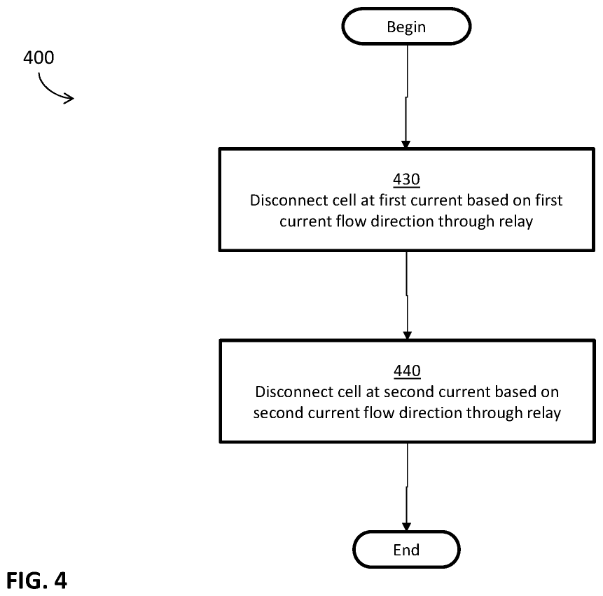

FIG. 4 depicts a representative high-level process 400 for electrochemical cell protection. The acts of representative process 400 are described in detail in the paragraphs that follow.

In some embodiments, representative process 400 may include act 430, wherein at least one electrochemical cell (such as electrochemical cell 121A described elsewhere herein) may be disconnected at a first threshold current magnitude based on a first current flow direction through at least one relay (which may be part of circuitry 118 described elsewhere herein).

In some embodiments, the cell(s) may be connected or re-connected to a charging source or load after or before act 430 and/or act 440.

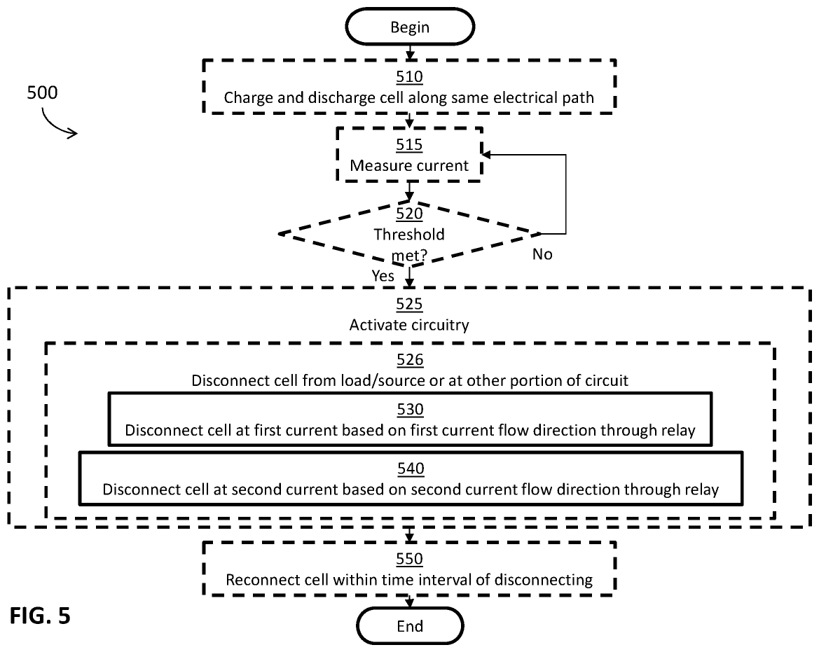

In some embodiments, representative process 400 may proceed to act 440 or perform act 440 instead of act 430 (based on determinations described in more detail with regard to FIG. 5), wherein the cell(s) may be disconnected at a second threshold current magnitude based on a second current flow direction through the relay(s). In some embodiments, the first threshold current magnitude may be different from the second threshold current magnitude. In some embodiments, the first current flow direction may be different from the second current flow direction (e.g., these directions may be opposite each other).

For example, if the first current flow direction corresponds to discharging of the cell(s), and the operating current in the first current flow direction is 25 ampere or more (at any time or for a given interval of time), circuitry may disconnect the cell(s) from the charging source. On the other hand, according to some embodiments, if the second current flow direction corresponds to charging of the cell(s), and the operating current in the second current flow direction is 1 amperes or more (at any time or for a given interval of time), circuitry may disconnect the cell(s) from the load. In some embodiments, disconnecting the cell(s) from the load and from the charging source may be the same operation. For example, the cell(s) may be both charged and discharged along the same electrical path, as described elsewhere herein.

In some embodiments, process 400 may then end or repeat as necessary.

FIG. 5 depicts a representative process 500 for electrochemical cell protection. The acts of representative process 500 are described in detail in the paragraphs that follow.

In some embodiments, representative process 500 optionally may begin at act 510, wherein at least one electrochemical cell (e.g., 121A) may be both charged and discharged along the same electrical path (e.g., as described elsewhere herein).

In some embodiments, the cell(s) may be part of a battery pack (e.g., 210 shown in FIG. 3B).

In some embodiments, representative process 500 may then optionally proceed to act 515, wherein operating current in a first current flow direction and/or in a second current flow direction through at least one relay (which may be part of circuitry 118 described elsewhere herein) may be measured using at least one current measuring control (e.g., sensor 116 as described elsewhere herein). In some embodiments, act 515 may include determining the direction of the current flow. In some embodiments, the operating current in the first current flow direction and/or the operating current in the second current flow direction may be or include direct current.

In some embodiments, the relay(s) may be solid state (e.g., as described elsewhere herein).

In some embodiments, representative process 500 may then optionally proceed to act 520, wherein at least one threshold may be considered to determine if it has been met (e.g., as described elsewhere herein). For example, the threshold may be a threshold measurement of the operating current in the first current flow direction and/or the operating current in the second current flow direction, such as a threshold current of discharging or charging the cell(s). In some embodiments, the first current flow direction may correspond to discharging of the cell(s). Alternatively or additionally, the second current flow direction may correspond to charging of the cell(s). In some embodiments, the first threshold current magnitude and/or the second threshold current magnitude may be adjusted. For example, if something changes that requires the threshold current to be lower or higher for either direction, the threshold can be changed accordingly.

In some embodiments, the average operating current in the first current flow direction (e.g., the discharging direction) may be at least 2 times higher than the average operating current in the second current flow direction (e.g., the charging direction). For example, the average operating current in the first current flow direction may be 4 times higher than average operating current in the second current flow direction.

In some embodiments, if the threshold has been met, representative process 500 may then optionally proceed to act 525, wherein circuitry for disconnecting the cell(s) may be activated, such as by the controller (e.g., 114) (e.g., as described elsewhere herein). Alternatively, if the threshold has not been met, the operating currents may continue to be measured.

In some embodiments, the circuitry used to perform the described disconnection may be included within a single integrated circuit or as a single component.

In some embodiments, the cell(s) may be disconnected at one or more portions of the circuit.

In some embodiments, act 525 may optionally include act 526, wherein the cell(s) may be disconnected from a load and/or a charging source.

In some embodiments, act 526 may optionally include act 530, wherein the cell(s) may be disconnected at the first threshold current magnitude based on a first current flow direction through the relay(s) (e.g., as described elsewhere herein).

In some embodiments, representative process 500 may proceed to act 540 or perform act 540 simultaneously or with some overlap with act 530, wherein the cell(s) may be disconnected at the second threshold current magnitude based on a second current flow direction through the relay(s). In some embodiments, the first threshold current magnitude may be different from the second threshold current magnitude. In some embodiments, the first current flow direction may be different from the second current flow direction.

In some embodiments, process 500 may then optionally proceed to act 550, wherein the cell(s) may be reconnected within a time interval of disconnecting the cell(s) (e.g., as described elsewhere herein).

In some embodiments, process 500 may then end or repeat as necessary.

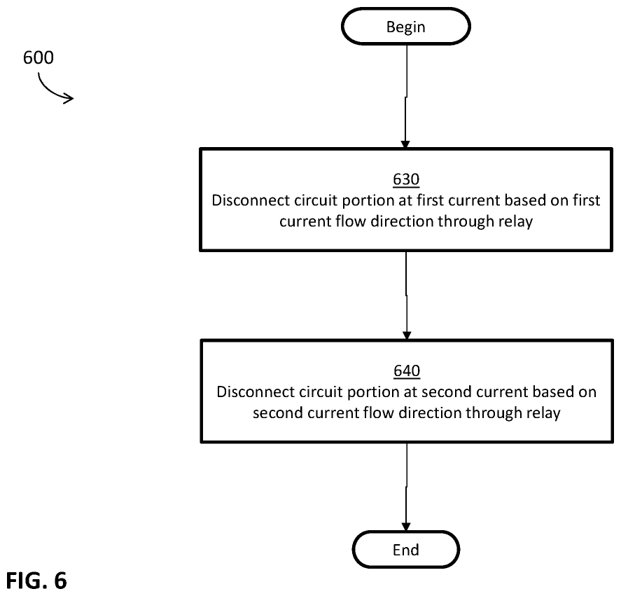

FIG. 6 depicts a representative high-level process 600 for circuit protection within a system. The acts of representative process 600 are described in detail in the paragraphs that follow.

In some embodiments, representative process 600 may include act 630, wherein at least one portion of a circuit within the system may be disconnected at a first threshold current magnitude based on a first current flow direction through at least one relay (which may be part of circuitry 118 described elsewhere herein).

In some embodiments, the circuit portion(s) may be connected or re-connected to a source or load after or before act 630 and/or act 640.

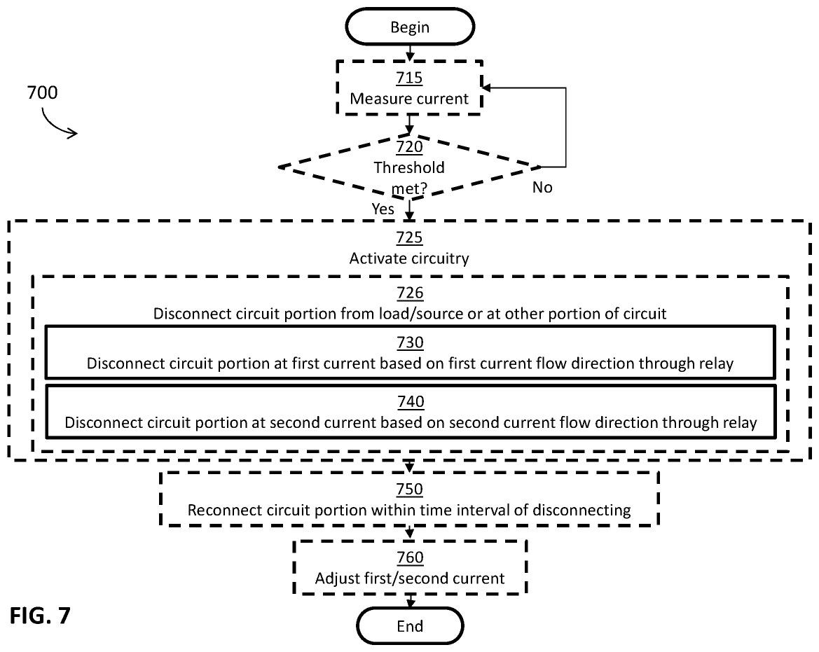

In some embodiments, representative process 600 may proceed to act 640 or perform act 640 instead of act 630 (based on determinations described in more detail with regard to FIG. 7), wherein the circuit portion(s) may be disconnected at a second threshold current magnitude based on a second current flow direction through the relay(s). In some embodiments, the first threshold current magnitude may be different from the second threshold current magnitude. In some embodiments, the first current flow direction may be different from the second current flow direction (e.g., these directions may be opposite each other).

For example, if the operating current in the first current flow direction is 1 ampere or more (at any time or for a given interval of time), circuitry may disconnect the circuit portion(s). On the other hand, if the operating current in the second current flow direction is 25 amperes or more (at any time or for a given interval of time), circuitry may disconnect the circuit portion(s).

In some embodiments, process 600 may then end or repeat as necessary.

FIG. 7 depicts a representative process 700 for circuit protection within a system. The acts of representative process 700 are described in detail in the paragraphs that follow.

In some embodiments, representative process 700 optionally may optionally begin at act 715, wherein operating current in a first current flow direction and/or in a second threshold current magnitude flow direction through at least one relay (which may be part of circuitry 118 described elsewhere herein) may be measured using at least one current measuring control (e.g., sensor 116 as described elsewhere herein). In some embodiments, act 715 may include determining the direction of the current flow. In some embodiments, the operating current in the first current flow direction and/or the operating current in the second current flow direction may be or include direct current.

In some embodiments, the relay(s) may be solid state (e.g., as described elsewhere herein).

In some embodiments, representative process 700 may then optionally proceed to act 720, wherein at least one threshold may be considered to determine if it has been met (e.g., as described elsewhere herein). For example, the threshold may be a threshold measurement of the operating current in the first current flow direction and/or the operating current in the second current flow direction. In some embodiments, the first threshold current magnitude and/or the second threshold current magnitude may be adjusted. For example, if something changes that requires the threshold current to be lower or higher for either direction, the threshold can be changed accordingly.

In some embodiments, the average operating current in the first current flow direction (e.g., the discharging direction) may be at least 2 times higher than the average operating current in the second current flow direction (e.g., the charging direction). For example, the average operating current in the first current flow direction may be 4 times higher than average operating current in the second current flow direction.

In some embodiments, if the threshold has been met, representative process 700 may then optionally proceed to act 725, wherein circuitry for disconnecting the circuit portion(s) may be activated, such as by the controller (e.g., 114) (e.g., as described elsewhere herein). Alternatively, if the threshold has not been met, the operating currents may continue to be measured.

In some embodiments, the circuitry used to perform the described disconnection may be included within a single integrated circuit or as a single component.

In some embodiments, the circuit portion(s) may be disconnected at one or more positions within the system.

In some embodiments, act 725 may optionally include act 726, wherein the cell(s) may be disconnected from a load and/or a charging source.

In some embodiments, act 726 may optionally include act 730, wherein the cell(s) may be disconnected at the first threshold current magnitude based on a first current flow direction through the relay(s) (e.g., as described elsewhere herein).

In some embodiments, representative process 700 may proceed to act 740 or perform act 740 simultaneously or with some overlap with act 730, wherein the cell(s) may be disconnected at the second threshold current magnitude based on a second current flow direction through the relay(s). In some embodiments, the first threshold current magnitude may be different from the second threshold current magnitude. In some embodiments, the first current flow direction may be different from the second current flow direction.

In some embodiments, process 700 may then optionally proceed to act 750, wherein the cell(s) may be reconnected within a time interval of disconnecting the cell(s) (e.g., as described elsewhere herein).

In some embodiments, process 700 may then optionally proceed to act 760, wherein the first threshold current magnitude and/or the second threshold current magnitude may be adjusted. For example, if something changes that requires the threshold current to be lower or higher for either direction, the threshold can be changed accordingly (e.g., as described elsewhere herein).

In some embodiments, process 700 may then end or repeat as necessary.

It should be appreciated that, in some embodiments, the methods described above with reference to FIGS. 4-7 may vary, in any of numerous ways. For example, in some embodiments, the steps of the methods described above may be performed in a different sequence than that which is described, a method may involve additional steps not described above, and/or a method may not involve all of the steps described above.

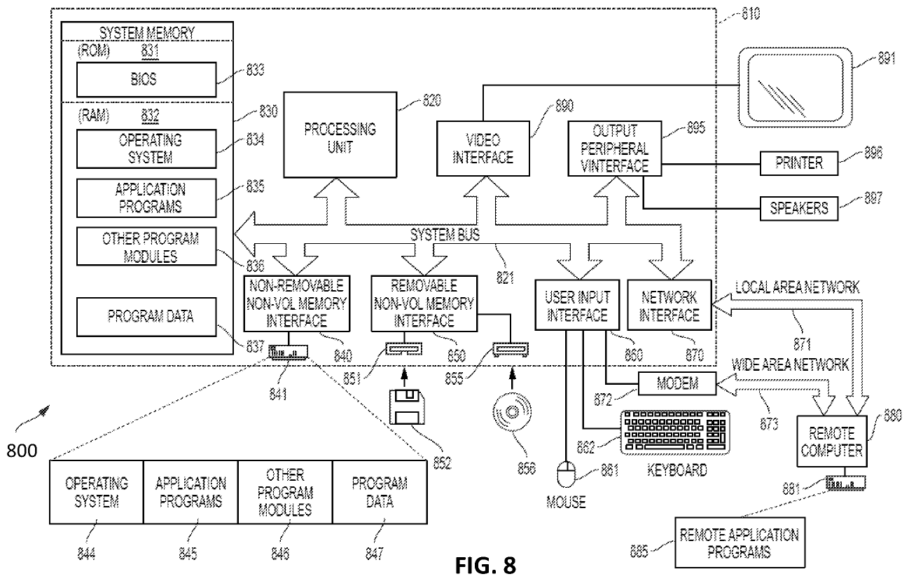

It should further be appreciated from the foregoing description that some aspects may be implemented using a computing device. FIG. 8 depicts a general purpose computing device in system 800, in the form of a computer 810, which may be used to implement certain aspects, such as any of the controllers described elsewhere herein (e.g., 114).

In computer 810, components include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media that may be used to store the desired information and may be accessed by computer 810. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 839 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 859 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 841 is typically connected to the system bus 821 through an non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 849, and program data 847. Note that these components can either be the same as or different from operating system 834, application programs 835, other program modules 539, and program data 837. Operating system 844, application programs 845, other program modules 849, and program data 847 are given different numbers here to illustrate that, at a minimum, they are different copies. A user may enter commands and information into the computer 810 through input devices such as a keyboard 892 and pointing device 891, commonly referred to as a mouse, trackball or touch pad. Other input devices (not shown) may include a microphone, joystick, game pad, satellite dish, scanner, or the like. These and other input devices are often connected to the processing unit 820 through a user input interface 590 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 899, which may be connected through a output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 890, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

Embodiments may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, some embodiments may be embodied as a computer readable medium other than a computer-readable storage medium. Examples of computer readable media that are not computer readable storage media include transitory media, like propagating signals.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention may include each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for protecting at least one electrochemical cell, the system comprising: circuitry configured to:
disconnect the at least one electrochemical cell at a first threshold current magnitude based on a first current flow direction through at least one relay; and
disconnect the at least one electrochemical cell at a second threshold current magnitude based on a second current flow direction through the at least one relay,
wherein the first current flow direction is different from the second current flow direction.

2. The system of claim 1, wherein the first threshold current magnitude is different from the second threshold current magnitude.

3. The system of claim 1, comprising at least one current measuring control configured to measure current in the first current flow direction and/or in the second current flow direction and, in response, activate the circuitry.

4. The system of claim 1, wherein the circuitry comprises the at least one relay.

5. The system of claim 1, wherein:
the first current flow direction corresponds to discharging of the at least one electrochemical cell,
the second current flow direction corresponds to charging of the at least one electrochemical cell, and
average operating current in the first current flow direction is at least 2 times higher than average operating current in the second current flow direction.

6. The system of claim 5, wherein average operating current in the first current flow direction is 4 times higher than average operating current in the second current flow direction.

7. The system of claim 1, wherein the system is enclosed as a single component or integrated circuit package.

8. The system of claim 1, wherein the circuitry is configured to adjust the first threshold current magnitude and/or the second threshold current magnitude.

9. The system of claim 1, wherein the circuitry is configured to disconnect the at least one electrochemical cell at one or more positions within the system.

10. The system of claim 1, wherein the at least one relay is solid state.

11. The system of claim 1, wherein the circuitry is configured to disconnect the at least one electrochemical cell from a load and/or a charging source.

12. The system of claim 1, wherein operating current in the first current flow direction and/or operating current in the second current flow direction comprise direct current.

13. The system of claim 1, wherein the at least one electrochemical cell is part of a battery pack.

14. The system of claim 1, wherein the at least one electrochemical cell is both charged and discharged along a same electrical path.

15. The system of claim 1, wherein the circuitry is configured to reconnect the at least one electrochemical cell within a time interval of disconnecting the at least one electrochemical cell.

16. A method for protecting at least one electrochemical cell, the method comprising:
disconnecting the at least one electrochemical cell at a first threshold current magnitude based on a first current flow direction through at least one relay; and
disconnecting the at least one electrochemical cell at a second threshold current magnitude based on a second current flow direction through the at least one relay,
wherein the first current flow direction is different from the second current flow direction.

17. The method of claim 16, wherein the first threshold current magnitude is different from the second threshold current magnitude.

18. The method of claim 16, wherein the method comprises measuring current in the first current flow direction and/or in the second current flow direction and, in response, activating circuitry to disconnect the at least one electrochemical cell.

19-30. (canceled)

31. A system comprising:
circuitry configured to:
disconnect at least one portion of a circuit at a first threshold current magnitude based on a first current flow direction through at least one relay; and
disconnect the at least one portion of the circuit at a second threshold current magnitude based on a second current flow direction through the at least one relay,
wherein the first current flow direction is different from the second current flow direction.

32-43. (canceled)

44. A method for protecting at least one portion of a circuit, the method comprising:
disconnecting the at least one portion of the circuit at a first threshold current magnitude based on a first current flow direction through at least one relay; and
disconnecting the at least one portion of the circuit at a second threshold current magnitude based on a second current flow direction through the at least one relay,
wherein the first current flow direction is different from the second current flow direction.

45-55. (canceled)
